(19) United States
(12) Patent Application Publication
(10) Pub. No.: US 2025/0079663 A1
(43) Pub. Date: Mar. 6, 2025

(54) BATTERY CELLS INCLUDING THERMALLY FUSED ENERGY DISCHARGE ELEMENTS

(71) Applicant: Solid Power Operating, Inc., Louisville, CO (US)

(72) Inventors: Joshua BUETTNER-GARRETT, Arvada, CO (US); Rose E. RUTHER, Lafayette, CO (US); Harris IQBAL, Louisville, CO (US); Saalik RAUF, Louisville, CO (US); Rene TREFFLER, Louisville, CO (US); Christoph NOWAK, Louisville, CO (US)

(21) Appl. No.: 18/827,487

(22) Filed: Sep. 6, 2024

Related U.S. Application Data
(60) Provisional application No. 63/536,842, filed on Sep. 6, 2023.

(51) Int. Cl. H01M 50/583; H01M 10/44

(52) U.S. Cl. CPC H01M 50/583; H01M 10/44; H01M 2200/103

(57) ABSTRACT

A battery cell is provided that includes a thermally fused energy discharge element that provides a cell discharge path between opposing electrodes at elevated temperatures.

### CROSS-REFERENCE TO RELATED APPLICATION

This application is related to and claims priority under 35 U.S.C. § 119 (e) from U.S. Patent Application No. 63/536,842 filed Sep. 6, 2023, titled “Battery Cells Including Thermally Fused Energy Discharge Elements,” the entire contents of which is incorporated herein by reference for all purposes.

### TECHNICAL FIELD

This disclosure relates to the field of electrochemical batteries and, in particular, this disclosure relates to a battery cell design to mitigate high temperature failure.

### BACKGROUND AND INTRODUCTION

The proliferation of battery powered devices including mobile computing devices and smart phones, and hybrid/electric automobiles among others, is motivating innovations in all aspects of battery technologies. Solid-state battery technologies represent opportunities to improve on a host of areas that are important for commercial application of batteries including reliability, capacity (mAh), thermal characteristics, safety, cycle life, and recharge performance, among others.

A solid-state battery includes a solid electrolyte between an anode and a cathode, forming an electrochemical cell. One key difference between a conventional liquid electrolyte battery and a solid-state battery is the use of a solid electrolyte. In a solid-state cell, the solid electrolyte serves the purpose of a separator and hence the solid electrolyte is often referred to as a separator. The electrochemical cell is often disposed within a pouch, bag, or similar structure to hermetically seal and protect the electrochemical cell and internal cell components. The anode and cathode may extend from the pouch or be electrically coupled to respective tabs or terminals that extend from the pouch to facilitate electrical connection to the electrochemical cell. A given battery may include one or more discrete cells with batteries having more and/or larger cells generally providing greater storage capacity than batteries having fewer/smaller cells.

In a lithium-based battery cell, which may serve as an example of the operation of other various types of cells, the anode (negative electrode) and cathode (positive electrode) store the lithium with positively charged lithium ions moving back and forth between the anode and the cathode through the electrolyte. During discharge, ions are released from the anode and flow, through the electrolyte, to the cathode whereas electrons flow from the anode to a load and back to the cathode. In a liquid electrolyte cell, a separator blocks the flow of electrons inside the battery directly from the anode to the cathode, which prevents self-discharge. In the case of solid-state cells, as noted above, there may not be a need for a distinct separator as the solid-state electrolyte serves the purpose of a separator.

While solid-state batteries may be considered safer than liquid electrolyte-based batteries due to an inherently lower risk of overheating and shorting, the substantial amount of energy potentially stored in a solid-state battery still motivates safety to be a top priority for manufacturers and users. Physical/mechanical damage, electrical shorting, overcharging, overheating and other similar events can still result in failure of a solid-state battery. Such safety concerns are particularly acute when designers and engineers need to account for possible damage to the battery (e.g., automotive applications given the likelihood that a battery-powered vehicle will be involved in a collision) or potential use of a battery in critical systems or hazardous environments.

Some or all of these and other issues are addressed by various aspects of the present disclosure discussed in detail below.

### SUMMARY

Aspects of the present disclosure involve a battery cell comprising a first auxiliary current collector and a first electrode of a first polarity. The battery cell further includes a first thermal fuse positioned between the first auxiliary current collector and a first current collector where the first current collector is positioned between the first thermal fuse and the first electrode of the first polarity. The first current collector is in conductive communication with the first electrode. The first thermal fuse is also positioned between the first auxiliary current collector and the first current collector where the first auxiliary current collector is in conductive communication with a second electrode of a second polarity, opposite the first polarity. The first thermal fuse electrically insulates the first auxiliary current collector from the first current collector and allows an electrical connection between the first auxiliary current collector and the first electrode at an elevated temperature (e.g., at a temperature where the thermal fuse element fully or partially melts, or at a temperature where the thermal fuse element fully or partially sublimates).

In various possible examples, the first thermal fuse is a phase change material that transitions from a solid phase to a liquid phase at the elevated temperature. The phase change material may transition to the liquid phase at a temperature in the range of 100° C. to 110° C. The phase change material may transition to the liquid phase at a temperature in the range of 100° C. to 170° C., or in a range of 100° C. to 200° C.

In some examples, the first thermal fuse is a coating on one of the first auxiliary current collector or the first electrode. The first thermal fuse is a layer that begins melting at the elevated temperature. In general, the term “elevated temperature” refers to a temperature above a normal operating temperature range for the battery cell, which temperature may vary depending on the type of battery cell. Such temperature ranges are typically specified, and the upper value of a range may be more relevant and define the elevated temperature. The elevated temperature may accommodate some safety margin, whether defined in degrees or percentages, above the specified upper limit for a particular cell so that the thermal fuse element does not improperly activate.

The battery cell may further be configured where the second electrode is in conductive communication with a second current collector, and where the first auxiliary current collector is in conductive communication with the second current collector. In such an arrangement, the first auxiliary current collector electrically connecting to the first current collector further electrically connects the first current collector to the second current collector by way of the conductive communication between the first auxiliary current collector and the first current collector at the elevated temperature. In some examples, the battery cell may further comprise a second auxiliary current collector and a second thermal fuse positioned between the second auxiliary current collector and the second current collector. In such an arrangement, the second current collector is positioned between the second thermal fuse and the second electrode, and the second current collector in electrical communication with the second electrode. In this arrangement, the second thermal fuse is positioned between the second auxiliary current collector and the second current collector such that the second thermal fuse provides electrical insulation between the second auxiliary current collector and the second current collector and provides an electrical connection between the second auxiliary current collector and the second electrode at the elevated temperature.

In various examples, the first electrode is an anode and the battery cell further comprises a solid-state electrolyte layer adjacent the anode. In further examples, the second electrode is a cathode and the battery cell further comprises a solid-state electrolyte layer adjacent the cathode.

In other examples, the battery cell may include a third auxiliary current collector adjacent a thermal barrier layer where the first auxiliary current collector and the thermal barrier layer are between the first thermal fuse and the first current collector, and the third auxiliary current collector is in conductive communication with the first current collector.

In various examples, the first thermal fuse may include a polyethylene and the thermal barrier layer may include a mica sheet.

In various examples, the battery cell includes a flexible pouch encapsulating the first auxiliary current collector and the first thermal fuse. In some examples, the first auxiliary current collector and the first thermal fuse are external to the pouch.

In another aspect of the present disclosure, a battery includes a first battery cell unit comprising a first electrode of a first polarity separated from a second electrode of a second opposing polarity by way of a solid electrolyte and a second battery cell unit comprising a third electrode of the first polarity separated from a fourth electrode of the second opposing polarity by way of a solid electrolyte. The battery further includes a thermal fuse between and electrically isolating the first battery cell unit and the second battery cell unit where the thermal fuse melting create a conductive path between the second electrode of the second opposing polarity with the third electrode of the first polarity.

In some examples, the first battery cell unit further comprises a first current collector in electrical communication with the first electrode of the first polarity and a second current collector in electrical communication with the second electrode of the second polarity, and the second battery cell unit further comprises a third current collector in electrical communication with the third electrode of the first polarity and a fourth current collector in electrical communication with the fourth electrode of the second polarity, with the thermal fuse interposed between the first current collector and the fourth current collector.

In some examples, the battery includes a first auxiliary current collector and a second thermal fuse between the first current collector and the first auxiliary current collector, where the first auxiliary current collector forms a conductive communication path with the fourth current collector when the thermal fuse reaches an elevated temperature.

Another aspect of the present disclosure involves a battery cell comprising a thermal fuse element electrically insulating an auxiliary current collector and a current collector, the current collector coupled with a first electrode of a first polarity, the auxiliary current collector in conductive communication with a second electrode of an opposing polarity to the first polarity, the thermal fuse element melting at an elevated temperature to discharge the battery cell by providing a conductive path between the first electrode and the second electrode. In some examples, the thermal fuse element is a phase change material that begins melting at the elevated temperature to provide the conductive path between the first electrode and the second electrode.

Another aspect of the present disclosure involves a method of discharging a battery, in a battery including a first electrode of a first polarity conductively coupled with a first current collector, and a first auxiliary current collector electrically separated from the first current collector by way of a first phase change layer, and a second electrode of a second polarity, opposite the first polarity, conductively coupled with a second current collector, the first auxiliary current collector conductively coupled with the second current collector, melting the first phase change layer to conductively couple the first electrode to the second electrode creating a discharge path therebetween.

### BRIEF DESCRIPTION OF THE DRAWINGS

The present disclosure may be understood by reference to the following detailed description taken in conjunction with the drawings briefly described below. It is noted that, for purposes of illustrative clarity, certain elements in the drawings may not be drawn to scale.

FIG. 1A is a representative side section view of a battery cell including thermally fused energy discharge elements according to one embodiment of the present disclosure.

FIG. 1B is a representative side section view of the battery cell of FIG. 1A with one thermally fused energy discharge element providing a conductive discharge path between opposing polarity electrodes of the battery cell.

FIG. 1C is a representative side section view of the battery cell of FIG. 1A with a second thermally fused energy discharge element providing a conductive discharge path between opposing polarity electrodes of the battery cell.

FIG. 2 is a top view of a pouched battery cell, which may include battery cells of various embodiments discussed herein.

FIG. 3A is a representative side section view of a battery cell including thermally fused energy discharge elements according to another embodiment of the present disclosure.

FIG. 3B is a representative side section view of a battery cell including thermally fused energy discharge elements according to another embodiment of the present disclosure.

FIG. 4 is a representative side section view of a battery cell including thermally fused energy discharge elements and a thermal barrier, according to another embodiment.

FIG. 5 is a representative side section view of a battery cell including thermally fused energy discharge elements and thermal barriers.

FIG. 6 is a diagram depicting adjacent pouch cells with thermal barrier layers arranged in a pack and depicting how the thermal barrier layers may shield adjacent pouch cells from a pouch cell experiencing elevated temperatures above normal operating temperature ranges.

FIG. 7 is a representative side section view of a battery cell including thermally fused energy discharge element interposed between battery cell layers within the battery cell according to one embodiment.

FIG. 8 is a representative side section view of a battery cell including a thermally fused energy discharge element interposed between battery cell layers within the battery cell according to another embodiment.

FIG. 9 is a representative side section view of a battery cell including a thermally fused energy discharge element external to the pouch according to one embodiment.

FIG. 10 is a representative side section view of a battery cell including a thermally fused energy discharge element external to the pouch according to another embodiment.

FIG. 11 is a representative side section view of a battery cell including a thermally fused energy discharge element external to the pouch according to another embodiment.

### DETAILED DESCRIPTION

Aspects of this disclosure are directed to a battery cell including a fusing mechanism that discharges a battery cell in high temperature events. Among other applications, the batteries described in this disclosure may be well-suited for use in mobile applications including automotive applications. While various aspects of the present disclosure are discussed with reference to solid-state batteries, it should be recognized that concepts may apply to other battery formats including those with liquid electrolyte. Additionally, while aspects of the disclosure may be particularly suited for mobile applications, the various aspects are by no means limited to the same.

The term “battery” in the art and herein can be used in various ways and may refer to an individual cell having an anode and cathode separated by an electrolyte, which may be a solid electrolyte, as well as a collection of such cells connected in various arrangements. A solid-state electrolyte cell may include more than one anode and cathode, separated by solid electrolyte layers, and may be encased within a flexible “pouch” that accommodates the expansion and contraction of the anode(s) and cathode(s) as the cell charges and discharges. Although many examples are discussed herein as applicable to a battery or a discrete cell, it should be appreciated that the systems and methods described may apply to many different types of batteries, battery chemistries, and may range from an individual cell to batteries involving different possible interconnections of cells such as cells coupled in parallel, series, and parallel and series. The electrodes (e.g., the cathodes and anodes) are in conductive communication with terminals or tabs that extend outside the pouch to enable electrical coupling of the battery to a battery terminal and/or to a circuit connecting multiple battery cells. The various implementations discussed herein may also apply to different structural battery arrangements including pouch cells and other cell structures that may accommodate size changes in the electrodes.

Conventional pouch structures rely on a tri-layer Polypropylene-Aluminum-Nylon (or “P-A-N”) construction. For example, certain conventional pouch cells are formed by positioning two P-A-N stacks on opposite sides of the cell with the polypropylene layers as the innermost layer of the stack, the nylon layer outwardly facing and the aluminum foil layer between them. Pressure and heat are subsequently applied to this sandwiched configuration to fuse the polypropylene layers together around the internal cell components, thereby sealing the internal cell components. The other layers of the pouch may be coupled to each other by an adhesive.

When the seal between the polypropylene layers becomes compromised, air/moisture can come into contact with the internal cell structure, leading to a possible thermal event as the air/moisture reacts with the various materials used within the cell. This can happen in a crash, for example, where the integrity of a battery is comprised from impact, compression, shock, or an external object penetrating the battery. In higher temperatures, oxygen can evolve from the cathode, which oxygen can react with other battery materials generating more heat. Oxygen evolution tends to be the greatest when the cathode is fully delithiated—fully charged. Such thermal and oxygen releasing events can further damage the polypropylene layers, resulting in further compromise of the seal and increase internal heating, which can propagate the thermal event between other cells in a pouch and/or to adjacent batteries. In certain situations, thermal events can cause cell temperatures to rise to the point of the nylon and polypropylene melting or combusting leading to a catastrophic failure of the cell. When such a failure occurs in conventional batteries, damage can quickly spread to other cells within the battery, other battery components, and any device or equipment within which the battery is installed.

To address the issues noted above, among others, battery cells according to this disclosure are configured to self-discharge when cell temperatures reach levels indicative or otherwise associated with some sort of failure event. By self-discharging, the stored energy potential of a particular cell or cells experiencing a failure may be released potentially isolating the failure and helping prevent it from spreading to other batteries in a pack.

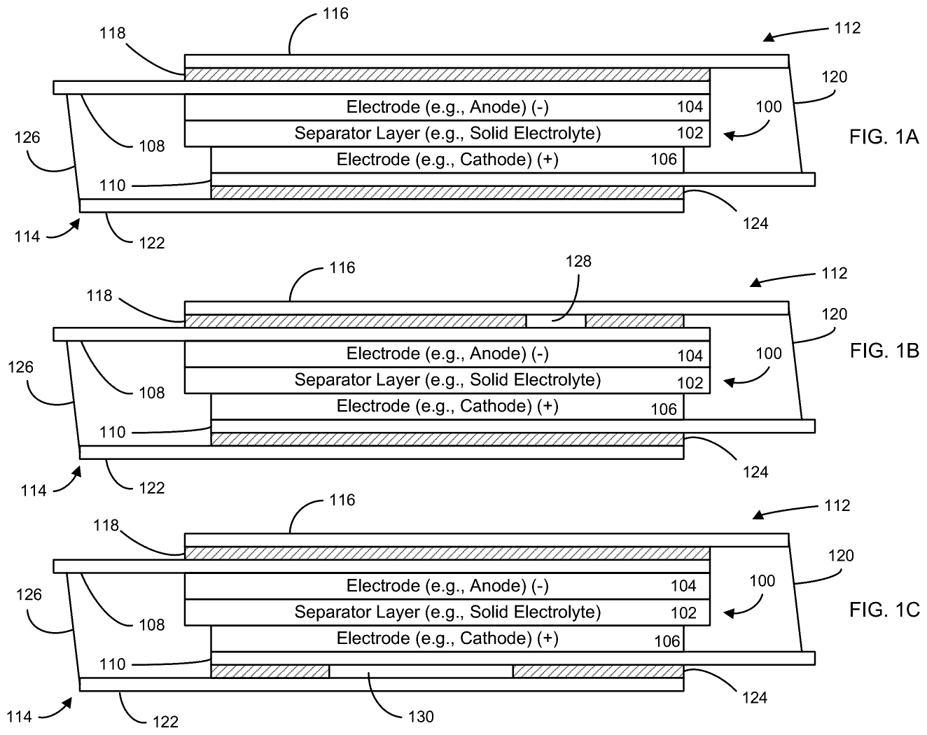

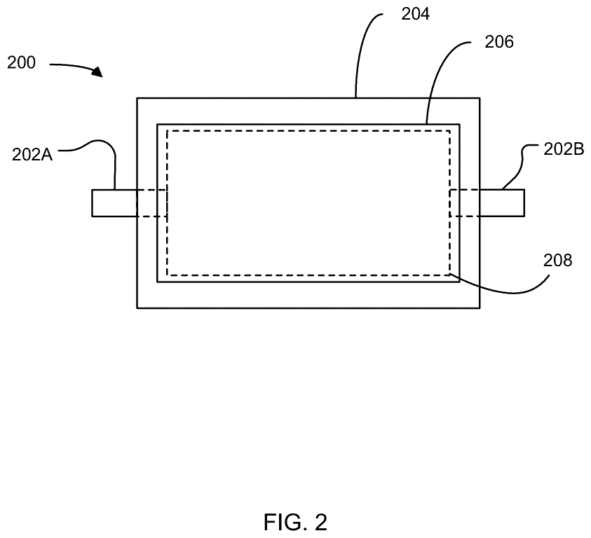

FIG. 1A illustrates a battery cell 100 according to various aspects of the present disclosure. In this example, the battery cell includes a separator layer 102 that is a solid electrolyte. As noted herein, however, aspects of the present disclosure are not limited to solid-state battery cells or cells with a solid electrolyte. The separator is positioned between two electrodes—the anode (−) 104 and the cathode (+) 106. The example battery cell 100 is a single cell; however, aspects of the disclosure apply to a battery comprising one or more discrete cells. In the illustrated example, the anode, solid-electrolyte, cathode stack is shown in a representative side view, and each layer of the stack comprises a relatively planar structure, typically a rectangle (as shown in FIG. 2). In the case of a pouch battery, the stack is encapsulated in a flexible pouch as discussed above. The anode is conductively coupled with an anode current collector 108 and the cathode is conductively coupled with a cathode current collector 110. In various possible examples, the current collectors are formed from a conductive foil or sheet and are in contact with the respective electrodes. While not shown, the current collectors are coupled with respective positive and negative tabs or other conductive structures by which the battery cell is connected to a load and/or other battery cells.

The battery cell further comprises a thermally fused energy discharge element 112. In the illustrated example, there is also a second thermally fused energy discharge element 114; however, various possible implementations may involve a battery with one or more thermally fused energy discharge elements. Referring to the first thermally fused energy discharge element, it includes a first auxiliary current collector 116 separated from the first (anode) current collector by a first thermal fuse element 118. The first thermally fused energy discharge element further comprises a conductive connection 120 to the cathode, which is shown in the example as an electrical connection to the cathode current collector.

The thermal fuse element (or simply thermal fuse) is electrically insulating in normal battery operation. As such, the anode current collector is electrically or conductively isolated from the first auxiliary current collector. Thus, the anode is electrically isolated from the cathode as would normally be the case for a battery cell. However, in the event of any thermal event that causes the temperature of the cell to rise above some threshold, which may be a range of temperatures, the thermal fuse begins to melt or otherwise alter its conductive properties, e.g., decrease in resistance, to provide a conductive path between the electrode (e.g., anode) and the auxiliary current collector (e.g., first auxiliary current collector). In some examples discussed herein, a thermal fuse is a material that is positioned between at least two electrically conductive materials where, upon heating, transitions from a solid electrically insulating state to a state that allows the at least two electrically conductive materials to make contact or otherwise allow a conductive path therebetween. The term auxiliary current collector is meant to encompass any form of conductive structure that electrically contacts the electrode when the thermal fuse element activates, and forms a portion of an electrical path to the other electrode. The discharge path formed between the opposite electrodes, e.g., from the anode to the cathode when some or all of the first thermal fuse melts, discharges the stored energy in the battery cell.

The thermal fuse element, which may be a phase change material, may have a melting transition temperature range of between 100° C. and 110° C. In another example, the melting range may be between 100° C. and 170° C. In another example, the thermal fuse element melts between 110° C. to 140° C. The melting temperature for the thermal fuse element may be selected based on the battery chemistry and the temperatures at which thermal effects have various deleterious effects on the battery cell including oxygen release as discussed above, thermal runaway and the like. As such, the examples above should not be considered limiting as the temperature threshold or range for any given application may vary based on a number of factors.

Similarly, the material may be selected based on such possible applications. The thermal fuse element may comprise various possible compounds, resins, polymers, coatings and the like. The thermal fuse element may be a discrete layer from a foil or sheet or may be applied to the current collector or the auxiliary current collector as a coating or otherwise. In one example, the thermal fuse element is a polyethylene separator, which is a component often used in conventional liquid electrolyte cells as a separator between the anode and cathode. Polyethylene separators are often supplied in a roll and may be thus applied in a battery manufacturing process where the polyethylene sheet from the roll provides a distinct layer in the cell stack at the electrode.

In various possible alternatives, the thermal fuse element may be a polyolefin separator, which would also include a polyethylene and a polypropylene separator. In general, the thermal fuse element may also include various possible polymers with melting points between 100° C. and 200° C., such as provided by some acetals, nylons, CAB, PVC, PVDF. In other alternatives, the thermal fuse element may use waxes or resins that melt in the range of between 100° C. and 200° C. Still other compounds that melt or sublime in the temperature range may be used, alone or in various combinations. Besides melting or sublimating, materials that soften or dimensionally alter sufficiently at an elevated temperature to allow for a conductive path to form may also be considered. For example, when using a polymer thermal fuse, the polymer separates two current collectors. Since some solid state battery cells require a compressive force to operate well, in some instances when the polymer begins to soften as temperature rise, and not necessarily melting, the polymer may soften sufficiently to push out of the way in some locations and allow the current collectors to touch and form a conductive path. In these instances, and others, the polymer need not fully melt (convert from solid to liquid) for the thermal fuse to work and allow a conductive path to form.

As noted, a battery cell may include one or more thermally fused energy discharge elements. Referring still to FIG. 1A, a second such element 114 is shown at the cathode. Here, the second element includes a second auxiliary current collector 122 separated (and electrically insulated) from the cathode current collector by a second thermal fuse element 124. The second auxiliary current collector is conductively coupled 126 with the opposing electrode, e.g., the anode, by way of a second conductive connection to the anode current collector. In the case of either auxiliary current collector, the conductive connection to the opposing portion (+ to −, or − to +) of the battery may take a variety of forms including a connection to a conductive rail where multiple battery tabs may be connected, a direct connection to one or more opposing tabs, and otherwise.

The second thermally fused energy discharge element works like the first; namely, at or above some threshold temperature, the second thermal fuse element begins to melt or otherwise its resistance meaningfully drops to form a conductive path between the cathode current collector (and hence the cathode) and the second auxiliary current collector. Since the auxiliary current collector is conductively coupled with the anode, a direct conductive pathway is formed between the cathode and anode of the cell, around the separator layer, thereby allowing the cell to discharge its stored energy capacity.

FIG. 1B illustrates a situation where a portion of the first thermal fuse element 118 has melted forming a conductive path 128 between the anode current collector and the first auxiliary current collector, thereby where the first thermally fused energy discharge element forms an energy discharge path between the anode and the cathode. FIG. 1C illustrates a situation where a portion of the second thermal fuse element 124 has melted forming a conductive path 130 between the cathode current collector and the second auxiliary current collector, thereby where the second thermally fused energy discharge element forms an energy discharge path between the cathode and the anode. In both examples, it should be recognized that the figures are not necessarily to scale and in either example the auxiliary current collectors (116, 122) contacts the respective anode current collector 108 or cathode current collector 110 when the thermal fuse element melts to form a conductive connection between the respective auxiliary current collector and electrode current collector. In many instances, solid-state cells are operated under some amount of pressure or force to optimize contact between solid particles in the various anode, cathode, and or SSE layers of the cells, in normal operation. As such, the external pressure applied to the cells may enhance contact between the auxiliary current collectors and the respective electrode current collectors to cause a discharge when a thermal discharge layer melts, partially or completely.

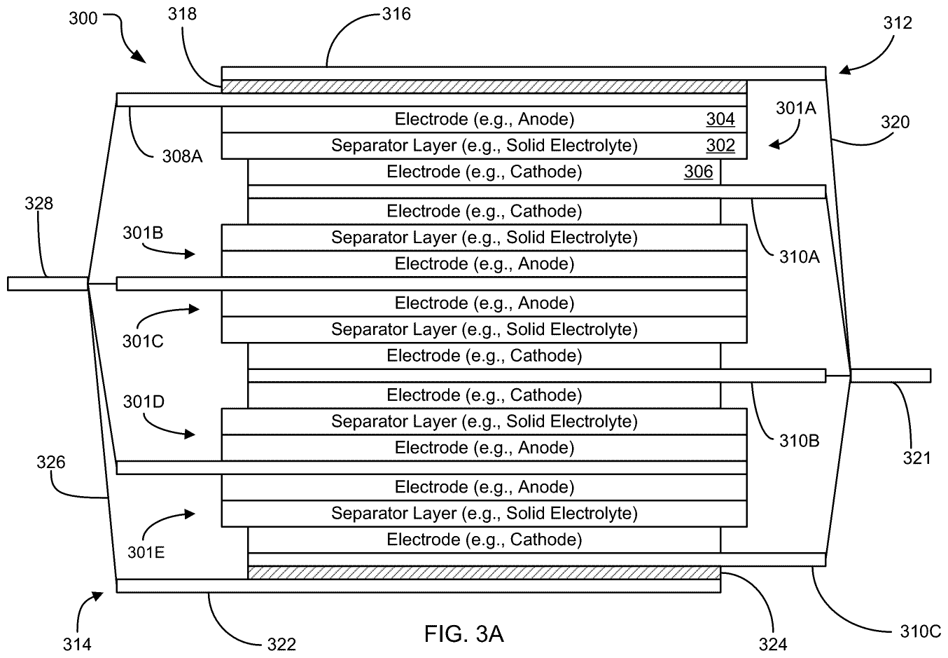

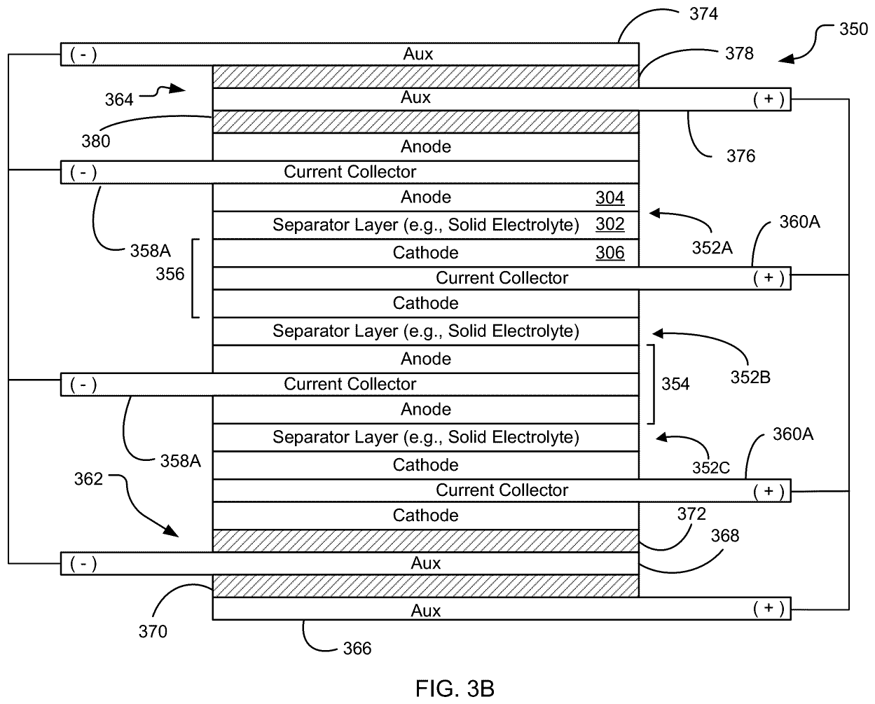

FIG. 2 is a representative top view of one possible example of a pouch cell 200, which include any of the various battery cells discussed herein including those in FIGS. 1, 3, and others. The pouch cell is generally rectangular in shape with conductive tabs 202A and 202B extending from each end of a respective pouch cell. In another arrangement, a pair of conductive tabs may extend from the same side of the cell. The conductive tab 202A from one end of the pouch cell is connected with the anode (or often anodes) of the cell, often at current collector(s) forming part of the layered structure and in electrical contact with the anode, and the conductive tab 202B at the other end of the pouch cell is connected with the cathode (or often cathodes) of the cell, also at the respective current collector(s), which also form part of the layered structure and are in electrical contact with the cathode. Pouch cells may be of varying configurations, shapes and sizes. In the representative example shown, there is a border area 204 where the outer flexible pouch material layers encapsulating the layered cell structure within is bonded and seals the layered structure within. The portion of the pouch 206 at the inner layered structure 208 is relatively wider than the sealed area and is the portion of the pouch subject to expansion and contraction from the battery cell structure 208 within.

FIG. 3A is an example of a battery cell 300 including a plurality of discrete cell units. In this example, each cell unit 301A-301E includes a separator layer 302 that is a solid electrolyte. The separator is positioned between two electrodes—the anode (−) 304 and the cathode (+) 306. In the illustrated example, the anode, solid-electrolyte, cathode stack is shown in a representative side section view, and each layer of the stack comprises a relatively planar structure, typically a rectangle, such as shown for example in FIG. 2 in dashed line 208. In the case of a pouch battery, the stack is encapsulated in a flexible pouch as discussed. The anode is conductively coupled with an anode current collector 308 and the cathode is conductively coupled with a cathode current collector 310. In various possible examples, the current collectors are formed from a conductive foil or sheet and are in contact with the respective electrodes. In various examples and in combination with different material electrodes, the current collectors may be formed of aluminum or copper foils. The current collectors are coupled with a respective positive or negative tab or other conductive structures by which the battery cell is connected to a load and/or other battery cells. It can be seen that the battery includes repeating cell structures in an alternating arrangement so that anodes or cathodes of adjacent cell units are each in conductive contact with the appropriate current collector.

In the arrangement of FIG. 3, the battery further includes a thermally fused energy discharge element 312. In the illustrated example, there is also a second thermally fused energy discharge element 314; however, various possible implementations may involve a battery with one or more thermally fused energy discharge element. In this embodiment, the thermally fused discharge element is adjacent the outer most cell units 301A and 301E. Referring to the first thermally fused energy discharge element, it includes a first auxiliary current collector 316 separated from the first, anode, current collector by a first thermal fuse element 318. The first thermally fused energy discharge element further comprises a conductive connection 320 to the cathode, which is shown in the example as an electrical connection to a tab 321 of the cathode current collectors. Alternatively, the first auxiliary current collector may be coupled with any of the discrete cathode current collectors 310A-310C of the various cell units, including the nearest cathode current collector 310A.

As discussed above with regard to FIGS. 1A-1C, the thermal fuse element is electrically insulating in normal battery operation. As such, the anode current collector 308A is electrically or conductively isolated from the first auxiliary current collector 316. Thus, the anode is electrically isolated from the cathode as would normally be the case for a battery cell. However, in the event of any thermal event that causes the temperature of the cell to rise above some threshold, which may be a range, the thermal element begins to melt or otherwise alter its conductive properties, e.g., decrease in resistance, to provide a conductive path between the electrode (e.g., anode) and the auxiliary current collector (e.g., first auxiliary current collector). The term auxiliary current collector is meant to encompass any form of conductive structure that electrically contacts the electrode when the thermal fuse element melts or otherwise transitions to a conductive state and forms a portion of an electrical path to a cathode. The discharge path formed between the opposite electrodes, e.g., from the anode to the cathode when some or all of the first thermal fuse melts, discharges the stored energy in the battery cell.

In a battery cell with a plurality of cell units, each of the anodes (−) and each of the cathodes (+) are conductively coupled with a respective negative tab or positive tab, representing the opposing polarities of the battery. In some arrangements, like shown in FIG. 3A, cell units are layered in an alternating pattern so that anodes or cathodes are facing each other, and may thus share a common current collector, which in turn are coupled with the appropriate tabs.

As noted, a battery cell may include one or more thermally fused energy discharge elements. Referring still to FIG. 3A, a second such element 314 is shown at the cathode current collector 310C of the opposing outside cell unit 301E. Here, the second element includes a second auxiliary current collector 322 separated (and electrically insulated) from the cathode current collector by a second thermal fuse element 324. The second auxiliary current collector is conductively coupled 326 with the opposing electrode, e.g., the anode, by way of a second conductive connection to the anode current collector. In the case of either auxiliary current collector, the conductive connection to the opposing portion (+ to −, or − to +) of the battery may take a variety of forms including a connection to a conductive rail where multiple battery tabs may be connected, a direct connection to one or more opposing tabs (e.g., tab 328), connection to one or more opposing current collectors, and otherwise.

The second thermally fused energy discharge element works like the first; namely, at or above some threshold temperature, the second thermal fuse element begins to melt or otherwise changes phase and/or its resistance meaningfully drops to form a conductive path between the cathode current collector (and hence the cathode) and the second auxiliary current collector. Since the second auxiliary current collector is conductively coupled with the anode, a direct conductive pathway is formed between at least one of the cathodes and at least one of the anodes of the battery, around the separator layer (or layers), thereby allowing the battery to discharge its stored energy capacity.

FIG. 3B is an example of a battery cell 350 including a plurality of discrete cell units. In this example, each cell unit 352A-352C includes a separator layer 302 that is a solid electrolyte. The separator is positioned between two electrodes—the anode (−) 304 and the cathode (+) 306. In the illustrated example, the anode, solid-electrolyte, cathode stack is shown in a representative side section view, and each layer of the stack comprises a relatively planar structure, typically a rectangle, such as shown for example in FIG. 2 in dashed line 208. Here, the cell units are assembled from alternating anode and cathode assemblies. An anode assembly 354 is formed from anode layers cast on or otherwise formed on both sides of a current collector 358A. Similarly, a cathode assembly 356 is formed from cathode layers cast or otherwise formed on both sides of a current collector 360A. In the case of a pouch battery, the stack is encapsulated in a flexible pouch as discussed. The anodes are conductively coupled with anode current collectors 358A and the cathodes are conductively coupled with cathode current collectors 360A. In various possible examples, the current collectors are formed from a conductive foil or sheet and as noted, in this implementation, the electrodes are formed on either side of the current collectors. In various examples and in combination with different material electrodes, the current collectors may be formed of aluminum or copper foils. The current collectors are coupled with a respective positive or negative tab or other conductive structures by which the battery cell is connected to a load and/or other battery cells. It can be seen that the battery includes repeating cell structures in an alternating arrangement so that anodes or cathodes of adjacent cell units are each in conductive contact with the appropriate current collector.

In the arrangement of FIG. 3B, the battery further includes a thermally fused energy discharge element 362. In the illustrated example, there is also a second thermally fused energy discharge element 364; however, various possible implementations may involve a battery with one or more thermally fused energy discharge element. In this embodiment, the thermally fused discharge elements are on the outside ends of the functional cell unit stack. Referring to the first thermally fused energy discharge element, it includes a first auxiliary current collector 366 and a second auxiliary current collector 368 separated from each other by a phase change layer 370 such that the first and second auxiliary current collectors are not in electrical contact during normal operation. The second, inside auxiliary collector 368, is separated from the electrode (here a cathode) by a second phase change layer 372. Thus, the second auxiliary current collector is not normally in electrical/conductive contact with the electrode. In this example, the inner (second) auxiliary current collector is coupled with the anode current collectors. The outer (first) auxiliary current collector is coupled with the opposing cathode current collector.

Referring to the second thermally fused energy discharge element 364, it includes a third auxiliary current collector 374 and a fourth auxiliary current collector 376 separated from each other by a phase change layer 378 such that the first and second auxiliary current collectors are not in electrical contact during normal operation. The fourth, inside auxiliary collector 376, is separated from the electrode (here an anode) by a second phase change layer 380. Thus, the fourth auxiliary current collector is not normally in electrical/conductive contact with the electrode. In this example, the inner (fourth) auxiliary current collector is coupled with the cathode current collectors. The outer (third) auxiliary current collector is coupled with the opposing anode current collector.

As discussed herein, the thermal fuse elements (referred to in this example as phase change layers) is electrically insulating in normal battery operation. As such, the anode and cathode current collectors are electrically or conductively isolated from the inner auxiliary current collectors 368 and 376. Thus, the anodes are electrically isolated from the cathodes as would normally be the case for a battery cell. However, in the event of any thermal event that causes the temperature of the cell to rise above some threshold, which may be a range, one or more of the thermal elements will begin to melt or otherwise alter its conductive properties, e.g., decrease in resistance, to provide a conductive path between the electrode (e.g., cathode) and the adjacent auxiliary current collector (e.g., the first auxiliary current collector 368). The inner auxiliary current collectors are coupled with an opposing polarity electrode. As such, when the inner material melts a conductive discharge path is formed when the opposing polarities are connected. The term auxiliary current collector is meant to encompass any form of conductive structure that electrically contacts the electrode when the thermal fuse element melts or otherwise transitions to a conductive state and forms a portion of an electrical path to a cathode. The discharge path formed between the opposite electrodes, e.g., from the anode to the cathode when some or all of the first thermal fuse melts, discharges the stored energy in the battery cell.

In both instances, the respective outer auxiliary current collectors 366,374 are coupled to an opposing polarity from the inner auxiliary collectors 376,368. As such when the intervening phase change materials 370,378 melts, another path may be formed.

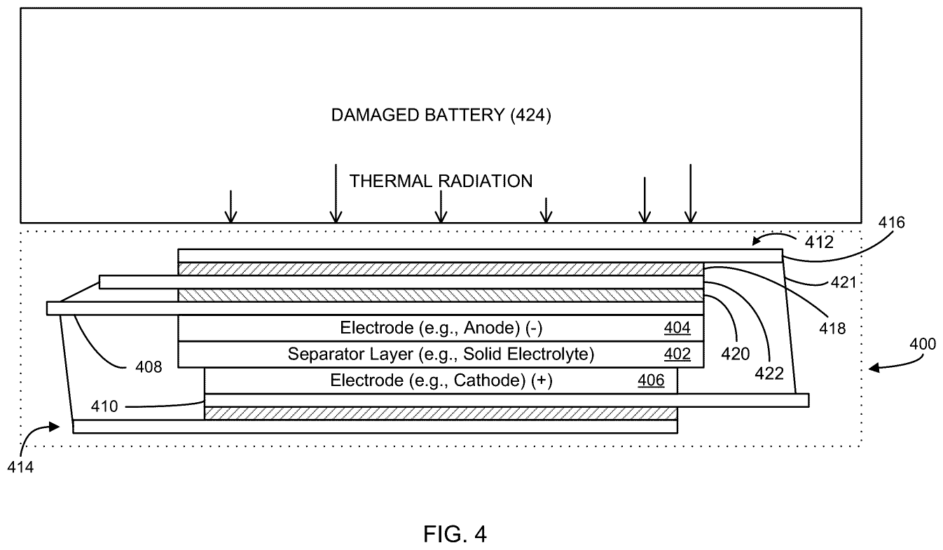

FIG. 4 illustrates a battery cell 400 according to various aspects of the present disclosure. In this example, the battery cell includes a separator layer 402 that is a solid electrolyte. As noted herein, however, aspects of the present disclosure are not limited to solid-state battery cells or cells with a solid electrolyte. The separator is positioned between two electrodes—the anode (−) 404 and the cathode (+) 406. The example battery cell 400 has a single cell structure for illustrative purposes; however, aspects of the disclosure apply to a battery comprising one or more discrete cell units in various possible arrangements. In the illustrated example, the cell unit stack comprising the anode, solid-electrolyte, and the cathode is shown in a representative side view, and each layer of the stack, if viewed from a top or bottom view, comprises a relatively planar structure, typically a rectangle. In the case of a pouch battery, the stack is encapsulated in a flexible pouch as discussed herein, with a representative top view (relative to the side section view of FIG. 4) of a pouch shown in FIG. 2. The anode is conductively coupled with an anode current collector 408 and the cathode is conductively coupled with a cathode current collector 410. In various possible examples, the current collectors are formed from a conductive foil or sheet and are in contact with the respective electrodes. While not shown, the current collectors are coupled with respective positive and negative tabs or other conductive structures by which the battery cell is connected to a load and/or other battery cells.

The battery cell further comprises a thermally fused energy discharge element 412. In the illustrated example, there is also a second thermally fused energy discharge element 414; however, various possible implementations may involve a battery with one or more thermally fused energy discharge elements. Referring to the first thermally fused energy discharge element, it includes a first auxiliary current collector 416 separated from the first, anode, current collector 408 by a first thermal fuse element 418. The first thermally fused energy discharge element further comprises a conductive connection 421 to the cathode, which is shown in the example as an electrical connection to the cathode current collector.

Unlike the embodiments of FIG. 1 or FIG. 3, the battery cell further includes a thermal barrier layer 420 and a third (additional) auxiliary current collector 422. Generally speaking, the thermal barrier layer shields the internal battery cell unit (or units) from external heat radiation. So, for example, if a neighboring battery 424 is damaged and radiating heat, the thermal barrier will shield the internal cell from heat radiation while allowing the thermally fused energy discharge element to activate and discharge the internal cell. In this case, the internal cell may be discharged proactively as the neighboring battery fails and before the internal cell is damaged and begins to fail itself. With the thermal barrier interposed between the thermally fused energy discharge element and the cell unit, the thermally fused energy discharge element may active before thermal energy penetrates the barrier sufficiently to damage the cells.

In the illustrated embodiment, the third auxiliary current collector 422 is positioned between the thermal barrier layer 420 and the phase change layer 418. The third auxiliary current collector is conductively coupled with the electrode (here the anode) current collector. As such, when the phase change layer transitions, e.g., partially or fully melts, a conductive path is formed between the first auxiliary current collector and the third auxiliary current collector. To complete the circuit and discharge the battery, the third auxiliary current collector 422 is coupled with the anode current collector 408 making the third auxiliary current collector effectively (electrically) the anode current collector. Thus, the discharge circuit is completed between the cathode and the anode when the phase change layer forms the conductive path to the third auxiliary current collector (effectively the anode current collector).

The thermal barrier layer may be formed of a mica sheet, in one example. The thermal barrier layer may also be any other material that is chemically inert (will not react with adjacent layers), is thermally stable at temperatures up to at least the melting or phase change temperature of the phase change layer. The thermal barrier layer may also be electrically insulating with relatively high dielectric strength. Other fire-resistant insulating materials may include polybenzimidazole fibers, aramids, mineral wools and ceramic fibers (silicate and aluminosilicate).

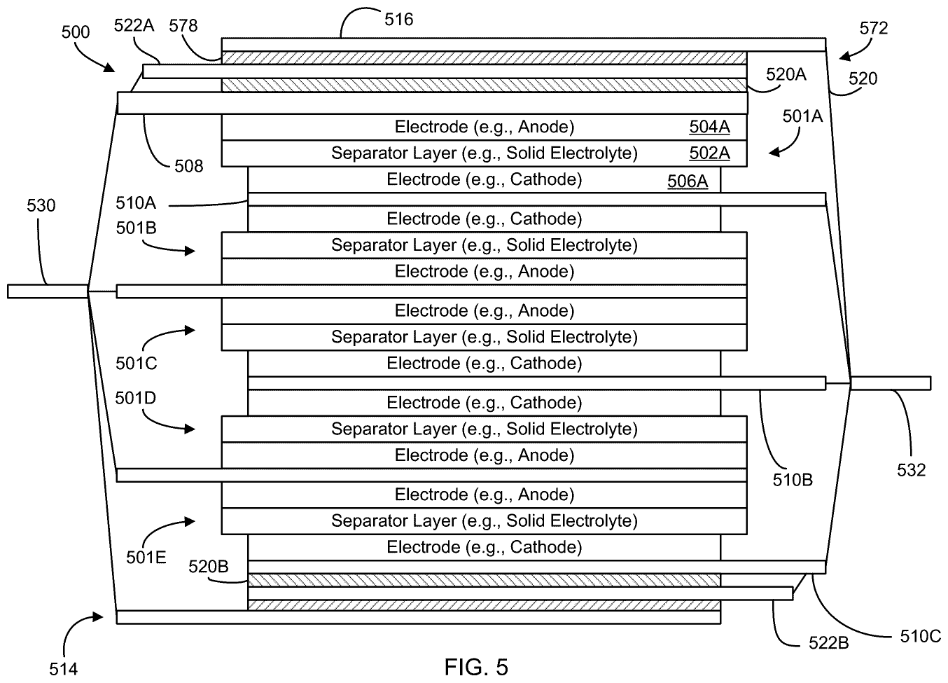

As noted, in the embodiment shown in FIG. 4, a thermal barrier is not shown at the cathode side of the battery; however, one may be positioned there. FIG. 5 illustrates a battery cell 500 like shown in FIG. 3A and also including thermal barrier layers adjacent each thermally fused element and between the thermally fused discharge elements and the internal cell structures. The battery cell 500 includes a plurality of discrete cell units. In this example, each cell unit 501A-501E includes a separator layer 502A that is a solid electrolyte. The separator is positioned between two electrodes—the anode (−) 504A and the cathode (+) 506A. In the illustrated example, the stack including the anode, solid-electrolyte, and the cathode is shown in a representative side section view, and each layer of the stack comprises a relatively planar structure, typically a rectangle, which is shown in a representative view (dashed line) in FIG. 2. In the case of a pouch battery, the stack is encapsulated in a flexible pouch as discussed. The anode is conductively coupled with an anode current collector 508 and the cathode is conductively coupled with a cathode current collector 510. In various possible examples, the current collectors are formed from a conductive foil or sheet and are in contact with the respective electrodes. The current collectors are coupled with a respective positive 530 or negative 532 tab or other conductive structures by which the battery cell is connected to a load and/or other battery cells. It can be seen that the battery includes repeating cell structures in an alternating arrangement so that anodes or cathodes of adjacent cell units are each in conductive contact with the appropriate current collector.

In the arrangement of FIG. 5, the battery further includes a thermally fused energy discharge element 572. In the illustrated example, there is also a second thermally fused energy discharge element 514; however, various possible implementations may involve a battery with one or more thermally fused energy discharge element. In this embodiment, the thermally fused discharge element is adjacent the outer most cell unit 501A. Referring to the first thermally fused energy discharge element, it includes a first auxiliary current collector 516 separated from the first, anode, current collector by a first thermal fuse element 578. The first thermally fused energy discharge element further comprises a conductive connection 520 to the cathode, which is shown in the example as an electrical connection to a tab of the cathode current collectors. Alternatively, the first auxiliary current collector may be coupled with any of the discrete cathode current collectors 510A -510C of the various cell units, including the nearest cathode current collector 510A.

A first thermal barrier layer 520A and associated additional electrode (anode) current collector 522A are positioned between the first thermally fused discharge element 578 and the cell units, and a second thermal barrier layer 520B and associated additional electrode (cathode) current collector 522B are positioned between the second thermally fused discharge element 514 and the other outer most cell unit 501E. As such, the thermal barriers may shield the internal cell units from a heat generated from a failing cell to either side of the battery cell 500.

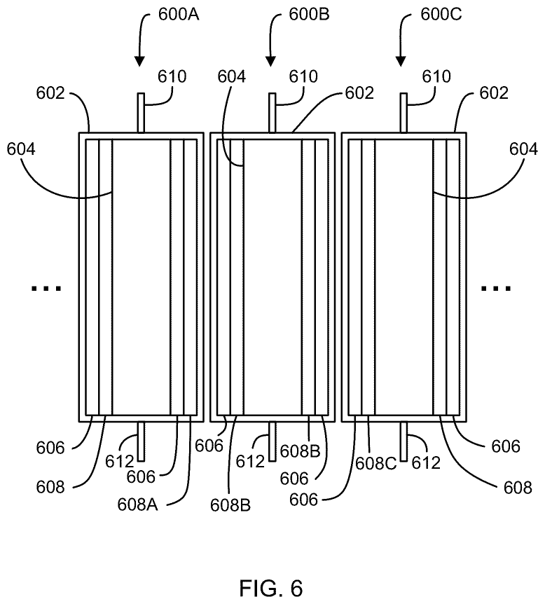

To illustrate how pouch cells may be arranged in a pack and how the thermal barriers may help shield thermal energy from cells to give a thermal fuse element time to activate, FIG. 6 illustrates three pouch cells 600A-600C in a top view. In battery pack, for example, pouch cells may be arranged, like books on a shelf, and may include many more than three pouch cells. In any event, each pouch cell includes an outer pouch 602 containing a cell structure 604. As noted above, a cell may include one or more cell units, including alternating stacks of current collector, anode, solid electrolyte separator, cathode, current collector arrangements. The cell portion of the pouch cell is positioned between thermally fused discharge elements 606 and thermal barrier elements 608. Tabs 610, 612, which are electrically coupled with the respective anodes and cathodes, by way of respective current collectors, extend from opposing ends of the pouch. It can be seen, that if the center cell 600B were to be failing and generative heat, the radiated heat from the cell would be shielded from pouch cells 600A, 600C to either side by the respective facing thermal barrier layers 608A, 608C in each adjacent cell, as well as the thermal barriers 608B within the failing cell. The thermal barriers 608B of the center cell may also trap some of the heat within the cell and/or direct heat laterally toward the sides of the cell where the tabs extend. The internal current collectors and tabs may also conduct some heat from the internal cell.

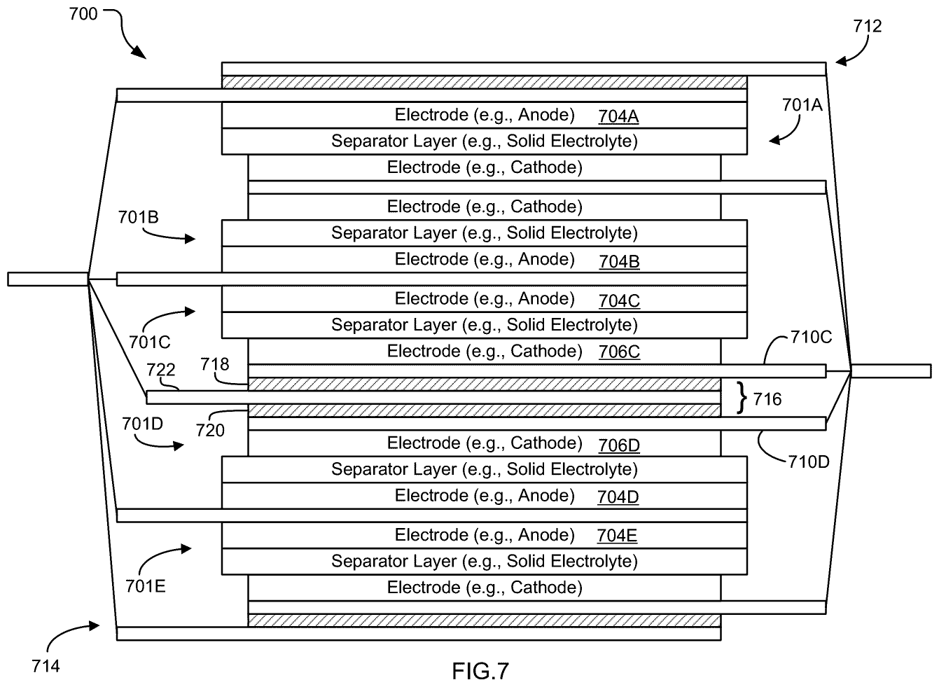

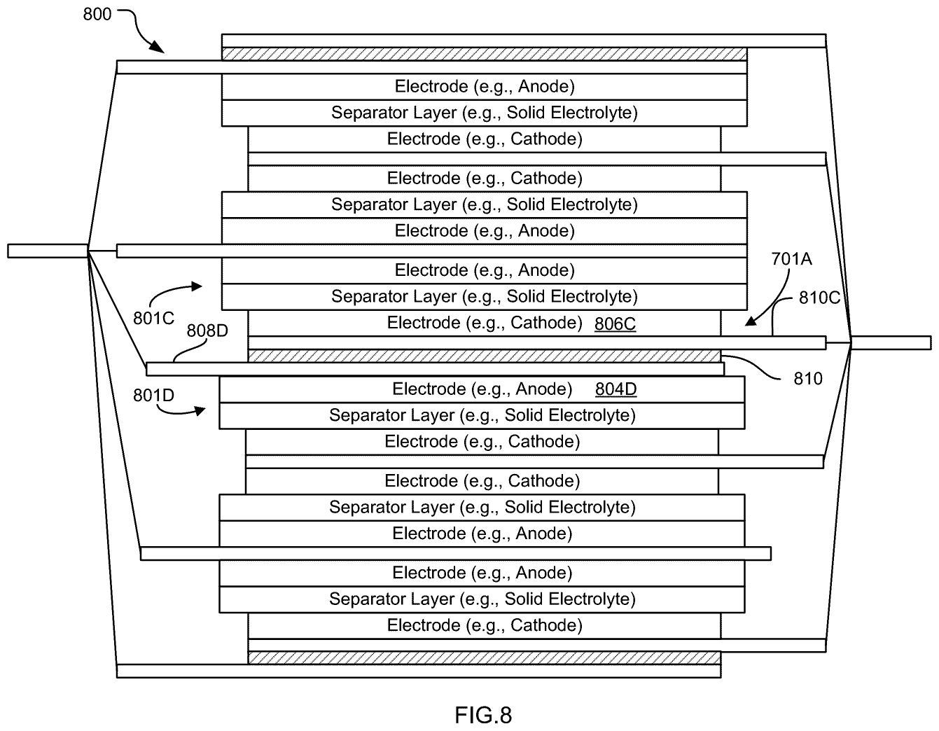

FIGS. 7 and 8 illustrate two embodiments of batteries with internal thermally fused energy discharge elements. Referring first to FIG. 7, it can be seen that the battery 700 includes multiple cell units 701A-701E with thermally fused discharge elements 712, 714 adjacent and outward of the outer cell units 701A and 701E. A thermally fused energy discharge element 716 is also positioned between the third 701C and fourth 701D cell units. In this arrangement, the third cell unit has its cathode 706C facing the cathode 706D of the fourth cell unit. Distinct current collectors 710C, 710D are positioned at each cathode, and also facing each other. Between the cathode current collectors, is a thermally fused energy discharge element comprising a first phase change layer 718 and a second phase change layer 720, with an auxiliary current collector 722 between the respective phase change layers. The auxiliary current collector is conductively coupled with the anodes 704 of the cell units but since it is normally electrically insulated from the respective cathode current collectors, there is not a conductive path between cathodes and anodes. When either or both phase change layers 718,720 become conductive or melt (partially or completely), the auxiliary current collector 722 becomes conductively coupled with one or both cathode current collectors 7060,706D forming a conductive short circuit path to the anode(s) 704 to discharge the cell units. The thermally fused discharge element may also be positioned between adjacent anodes (common electrodes), with the auxiliary current collector conductively coupled with the cathode(s) (opposing polarity common electrodes).

FIG. 8 illustrates an embodiment like FIG. 7 but where the battery cell 800 includes a thermally fused discharge element 802 positioned between adjacent cell units 801C, 801D where the cathode 806C and its current collector 810C of one cell unit faces the anode 804D and its current collector 808D of the adjacent cell unit. Here, the thermally fused discharge element includes a phase change layer 810 positioned between the opposing polarity current collectors (e.g., between the cathode current collector and the anode current collector) and hence between opposing polarity electrodes. When the phase change layer 810 melts or otherwise becomes conductive, the cathode current collector (and hence the cathode) of one cell unit directly contacts the anode current collector (and hence the anode) of the adjacent cell unit initiating a battery energy discharge.

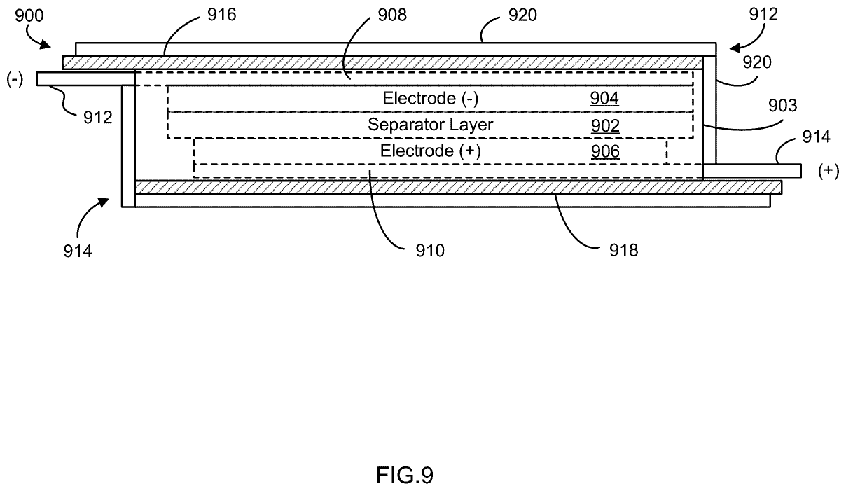

FIG. 9 illustrates a battery cell 900, including an encapsulating pouch 903, with external thermally fused energy discharge elements 912, 914. In this example, the thermally fused energy discharge elements are on the outside of the pouch, rather than being internal to the pouch with the cell units as illustrated in above embodiments. Here, repeating stacks of cell units (current collector 908, anode (electrode) 904, solid electrolyte separator 902, cathode (opposing polarity electrode) 906, current collector 910) are encapsulated in a pouch with respective tabs 912, 914 extending from the pouch. In some cases, internal cell units may share a current collector with the adjacent cell unit, e.g., when cathodes or anodes of adjacent cell units are facing each other. For ease of illustration, a representative cell unit is shown in FIG. 9.

A first phase change layer 916 is positioned on one face of the pouch and a second phase change layer 918 is positioned on the opposing face of the pouch. The first phase change layer extends over a portion of the first tab 912 and the second phase change layer extends over a portion of the second tab 914. The phase change layers do not extend the full length of the respective tabs, in this embodiment, to provide a connection point/surface for either tab to connect to a power rail, a load, etc. Along the first phase change layer 916, which overlaps the anode (−) tab, a conductive sheet 920 extends across the outer surface of the insulating/phase change layer 916 and is conductively coupled with the cathode (+) tab 914. When the portion of the phase change layer in contact with the anode tab melts, the conductive sheet creates a short circuit path to the cathode thereby discharging the pouch cell. The phase change layer may not extend along the entire surface of the pouch cell as shown. A portion of the phase change layer needs to extend along the length of the tab sufficient to electrically isolate (insulate) the outer conductive layer to the cathode from the anode until the phase change layer melts. The opposing external thermally fused energy discharge element works in the same way. The phase change layer 918 separates the outer conductive layer from the cathode tab 914. The outer conductive layer is conductively coupled with the anode tab 912. When the phase change layer melts a connection is formed between the cathode tab and the outer conductive layer thereby forming a short circuit path to the anode tab to discharge the cell.

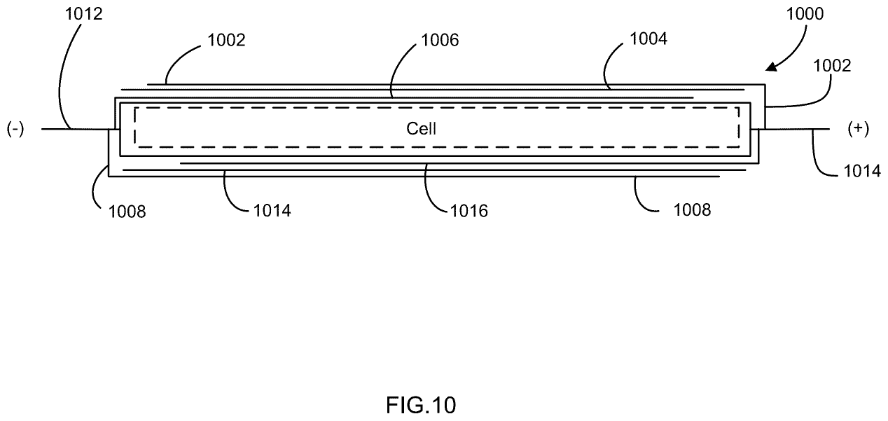

FIG. 10 is an alternative embodiment of a pouch cell 1000 with external thermally fused energy discharge elements. Here, a first conductive layer 1002, e.g., a conductive sheet, is coupled with the cathode tab 1014 and extends along a portion of an outer surface of the pouch. A first phase change layer 1004 electrically insulates the first outer conductive layer 1002 from a first conductive layer 1006 that is coupled with the anode tab 1012. It should be noted that the various layers are shown with a gap between them but in an assembled pouch the various layers may be pressed together, bonded together in some way, or formed from a coating such that little or no gaps would be present. When any portion of the first phase change layer 1004 becomes conductive or melts, a connection is formed between the first conductive layer 1006 and the first outer conductive layer 1002 thereby forming a short circuit path between the anode and cathode tabs to discharge the cell.

The opposing external thermally fused energy discharge element is arranged similarly. Namely, a second conductive layer 1008, e.g., a second conductive sheet, is coupled with the anode tab 1012 and extends along a surface of the pouch cell (opposite surface from the first conductive sheet). A second phase change layer 1014 is positioned between a second outer conductive layer 1016 and the second conductive sheet 1008. The second conductive layer is conductively coupled with the cathode tab 1014. When a portion of the second phase change layer 1014 melts or otherwise become conductive sufficient to form a conductive path between the second outer conductive layer 1016 and the second conductive sheet 1008, a short circuit path is formed between the respective opposing polarity tabs to discharge the cell.

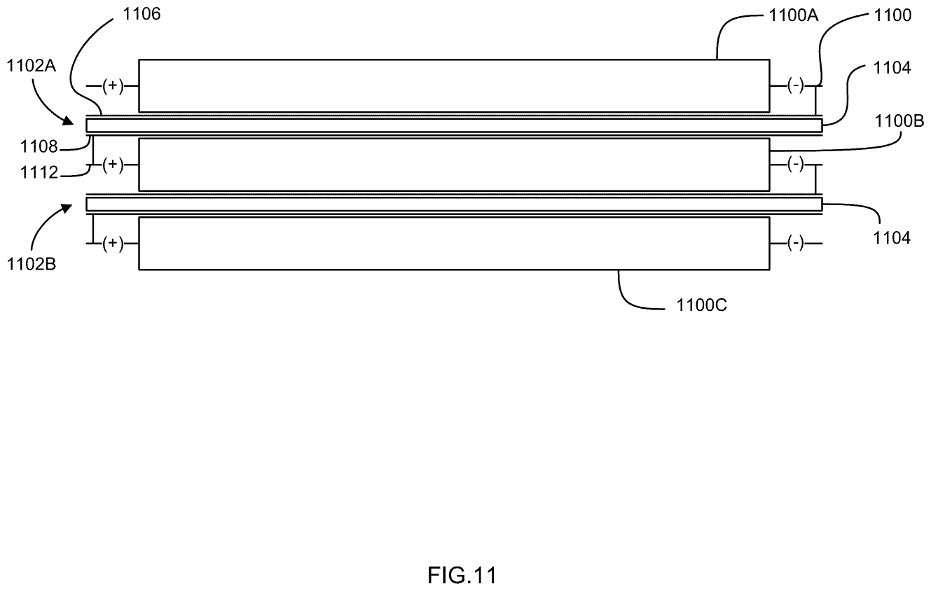

FIG. 11 illustrates an embodiment where discrete thermally fused energy discharge elements 1102A, 1102B are positioned between adjacent cells 1100A-1100C. The thermally fused discharge element includes a phase change material 1104 separated from adjacent cells by a first conductor 1106 and a second conductor 1108. The first conductor 1106 is conductively coupled with one tab of a battery cell, e.g., the negative tab 1100 of the first pouch cell 1100A. The second conductor 1108 is conductively coupled with an opposing polarity tab 1112, e.g., the positive tab, of an adjacent battery cell. The phase change layer electrically insulates the first conductor from the second conductor until it changes phase to provide a connection between the two conductors. Since the two conductors are coupled with opposing polarity tabs of adjacent cells, each cell may discharge when the phase change layer melts or otherwise becomes conductive from heat, which may be from the battery cells or otherwise.

Although various representative embodiments of this invention have been described above with a certain degree of particularity, those skilled in the art could make numerous alterations to the disclosed embodiments without departing from the spirit or scope of the inventive subject matter set forth in the specification. All directional references (e.g., upper, lower, upward, downward, left, right, leftward, rightward, top, bottom, above, below, vertical, horizontal, clockwise, and counterclockwise) are only used for identification purposes to aid the reader's understanding of the embodiments of the present invention, and do not create limitations, particularly as to the position, orientation, or use of the invention unless specifically set forth in the claims. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

In some instances, components are described with reference to “ends” having a particular characteristic and/or being connected to another part. However, those skilled in the art will recognize that the present invention is not limited to components which terminate immediately beyond their points of connection with other parts. Thus, the term “end” should be interpreted broadly, in a manner that includes areas adjacent, rearward, forward of, or otherwise near the terminus of a particular element, link, component, member or the like. In methodologies directly or indirectly set forth herein, various steps and operations are described in one possible order of operation, but those skilled in the art will recognize that steps and operations may be rearranged, replaced, or eliminated without necessarily departing from the spirit and scope of the present invention.

Various modifications and additions can be made to the exemplary embodiments discussed without departing from the scope of the present invention. For example, while the embodiments, also referred to as implementations or examples, described above refer to particular features, the scope of this invention also includes embodiments having different combinations of features and embodiments that do not include all of the described features. Accordingly, the scope of the present invention is intended to embrace all such alternatives, modifications, and variations together and in various possible combinations of various different features of different embodiments combined to form yet additional alternative embodiments, with all equivalents thereof.

While specific embodiments are discussed, it should be understood that this is done for illustration purposes only. A person skilled in the relevant art will recognize that other components and configurations may be used without parting from the spirit and scope of the disclosure. Thus, the above description and drawings are illustrative and are not to be construed as limiting. Numerous specific details are described to provide a thorough understanding of the disclosure. However, in certain instances, well-known or conventional details are not described in order to avoid obscuring the description.

Reference to “one embodiment” or “an embodiment” means that a particular feature, structure, or characteristic described in connection with the embodiment is included in at least one embodiment of the disclosure. The appearances of the phrase “in one embodiment”, or similarly “in one example” or “in one instance”, in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Various features and advantages of the disclosure are set forth in the description above, and in part will be obvious from the description, or can be learned by practice of the herein disclosed principles. The features and advantages of the disclosure can be realized and obtained by means of the instruments and combinations particularly pointed out in the appended claims.

Features described above as well as those claimed below may be combined in various ways without departing from the scope hereof. The previous examples illustrate some possible, non-limiting combinations. It should thus be noted that the matter contained in the above description or shown in the accompanying drawings should be interpreted as illustrative and not in a limiting sense. The above-described embodiments should be considered as examples of the present disclosure, rather than as limiting its scope. In addition to the foregoing embodiments of inventions, review of the detailed description and accompanying drawings will show that there are other embodiments of such inventions. Accordingly, many combinations, permutations, variations, and modifications of the foregoing embodiments not set forth explicitly herein will nevertheless fall within the scope of this disclosure. The following claims are intended to cover generic and specific features described herein, as well as all statements of the scope of the present methods, systems, and devices, which, as a matter of language, might be said to fall there between.

What is claimed is:

1. A battery cell comprising:
a first auxiliary current collector;
a first electrode of a first polarity;
a first thermal fuse positioned between the first auxiliary current collector and a first current collector, the first current collector positioned between the first thermal fuse and the first electrode of the first polarity, the first current collector in conductive communication with the first electrode;
the first thermal fuse positioned between the first auxiliary current collector and the first current collector, the first auxiliary current collector in conductive communication with a second electrode of a second polarity, opposite the first polarity;
wherein the first thermal fuse electrically insulates the first auxiliary current collector from the first current collector and allows an electrical connection between the first auxiliary current collector and the first electrode at an elevated temperature.

2. The battery cell of claim 1 further comprising:
the second electrode in conductive communication with a second current collector, the first auxiliary current collector in conductive communication with the second current collector,
wherein the first auxiliary current collector electrically connecting to the first current collector further electrically connects the first current collector to the second current collector by way of the conductive communication between the first auxiliary current collector and the first current collector at the elevated temperature.

3. The battery cell of claim 2 further comprising:
a second auxiliary current collector;
a second thermal fuse positioned between the second auxiliary current collector and the second current collector, the second current collector positioned between the second thermal fuse and the second electrode, the second current collector in electrical communication with the second electrode;
the second thermal fuse positioned between the second auxiliary current collector and the second current collector;
wherein the second thermal fuse provides electrical insulation between the second auxiliary current collector and the second current collector and provides an electrical connection between the second auxiliary current collector and the second electrode at the elevated temperature.

4. The battery cell of claim 3 wherein the first electrode is an anode and further comprising a solid-state electrolyte layer adjacent the anode.

5. The battery cell of claim 3 wherein the second electrode is a cathode and further comprising a solid-state electrolyte layer adjacent the cathode.

6. The battery cell of claim 1 wherein the first thermal fuse is a phase change material that transitions from a solid phase to a liquid phase at the elevated temperature.

7. The battery cell of claim 1 further comprising:
a third auxiliary current collector adjacent a thermal barrier layer;
the third auxiliary current collector and the thermal barrier layer between the first thermal fuse and the first current collector, the third auxiliary current collector in conductive communication with the first current collector.

8. The battery cell of claim 6 wherein the phase change material transitions to the liquid phase at the elevated temperature in the range of 100° C. to 110° C.

9. The battery cell of claim 4 wherein the phase change material transitions to the liquid phase at the elevated temperature in the range of 100° C. to 170° C.

10. The battery cell of claim 1 wherein the first thermal fuse comprises a polyethylene.

11. The battery cell of claim 1 further comprising a flexible pouch encapsulating the first auxiliary current collector and the first thermal fuse.

12. The battery cell of claim 1 further comprising a flexible pouch and wherein the first auxiliary current collector and the first thermal fuse are external to the pouch.

13. The battery cell of claim 1 wherein the first thermal fuse is a coating on one of the first auxiliary current collector or the first electrode.

14. The battery cell of claim 1 wherein the first thermal fuse is a layer that begins melting at the elevated temperature.

15. The battery cell of claim 1 wherein the elevated temperature is above a normal operating temperature range for the battery cell.

16. A battery comprising:
a first battery cell unit comprising a first electrode of a first polarity separated from a second electrode of a second opposing polarity by way of a solid electrolyte;
a second battery cell unit comprising a third electrode of the first polarity separated from a fourth electrode of the second opposing polarity by way of a solid electrolyte; and
a thermal fuse between and electrically isolating the first battery cell unit and the second battery cell unit, the thermal fuse melting to create a conductive path between the second electrode of the second opposing polarity with the third electrode of the first polarity.

17. The battery of claim 13 wherein:
the first battery cell unit further comprises a first current collector in electrical communication with the first electrode of the first polarity and a second current collector in electrical communication with the second electrode of the second polarity;
the second battery cell unit further comprises a third current collector in electrical communication with the third electrode of the first polarity and a fourth current collector in electrical communication with the fourth electrode of the second polarity; and
the thermal fuse between the first current collector and the fourth current collector.

18. The battery of claim 14 further comprising a first auxiliary current collector and a second thermal fuse between the first current collector and the first auxiliary current collector, the first auxiliary current collector forming a conductive communication path with the fourth current collector when the thermal fuse reaches an elevated temperature.

19. A battery cell comprising:
a thermal fuse element electrically insulating an auxiliary current collector and a current collector, the current collector coupled with a first electrode of a first polarity, the auxiliary current collector in conductive communication with a second electrode of an opposing polarity to the first polarity, the thermal fuse element melting at an elevated temperature to discharge the battery cell by providing a conductive path between the first electrode and the second electrode.

20. The battery cell of claim 16 wherein the thermal fuse element is a phase change material that begins melting at the elevated temperature to provide the conductive path between the first electrode and the second electrode.

21. A method of discharging a battery comprising:
in a battery comprising:
a first electrode of a first polarity conductively coupled with a first current collector, and a first auxiliary current collector electrically separated from the first current collector by way of a first phase change layer; and
a second electrode of a second polarity, opposite the first polarity, conductively coupled with a second current collector, the first auxiliary current collector conductively coupled with the second current collector,
melting the first phase change layer to conductively couple the first electrode to the second electrode creating a discharge path therebetween.
